(19) United States
(12) Patent Application Publication
(10) Pub. No.: US 2012/0054740 A1
(43) Pub. Date: Mar. 1, 2012

(54) Techniques For Selectively Enabling Or Disabling Virtual Devices In Virtual Environments

(75) Inventors: Parag Chakraborty, Sunnyvale, CA (US); Dustin L. Green, Redmond, WA (US)

(73) Assignee: Microsoft Corporation, Redmond, WA (US)

(21) Appl. No.: 12/872,959

(22) Filed: Aug. 31, 2010

(51) Int. Cl. G06F 9/00; G06F 9/455

(52) U.S. Cl. 718/1; 713/2

(57) ABSTRACT

In exemplary embodiments, device capabilities, i.e., functions performed in a hardware device, can be selectively enabled/disabled in a virtual machine by modifying configuration information for a hardware device emulator. For example, the configuration information can be changed in order to cause a guest operating system to load a specific device driver that enables/disables select hardware capabilities in a virtual machine. Other techniques are described in the claims, detailed description, and drawings.

### BACKGROUND

Virtual machine platforms enable the simultaneous execution of multiple guest operating systems on a physical machine by running each operating system within its own virtual machine. In a virtual machine, hardware devices can be emulated or accessed via paravirtualized devices. Emulated devices are typically accessed by non-virtualized aware device drivers running in the guest. These device drivers access hardware by reading/writing to resources, e.g., memory mapped registers and allocated memory, of devices and in a virtualized environment, when a device driver attempts to read/write to a device resource, an intercept occurs and information that describes the action the device driver attempted to take is sent to the emulator. The emulator receives the information and works through a state machine to determine what the device driver attempted to do. Another way that a guest OS can access hardware devices is by using paravirtualized devices. Paravirtualized devices are optimized for a virtual environment. These devices expose interfaces for the guest OS (and applications) and send high-level messages to the virtual machine platform.

There are many reasons for exposing virtual devices with generic hardware capabilities, i.e., functions enabled by hardware, to guest operating systems. Hardware utilization is one exemplary reason for limiting the capabilities exposed in a virtual machine. In some instances, the physical hardware that can enable advanced capabilities is a scarce resource in a computer system. If each virtual machine was able to access the advanced capabilities of it the hardware device may be overwhelmed and shut-down.

While there are reasons for limiting the capabilities exposed in a virtual machine, as virtual desktops become more common it is envisioned that virtual machines will have to be able to process new workloads, some of which may require advanced hardware capabilities. For example, a workload may require advanced capabilities of a 3D graphics processing unit in order to render a 3D application such as a videogame or a high definition movie during a virtual desktop session. Since hardware resources capable of performing advanced functions may be scarce resources, it would be advantageous to be able to easily enable or disable their capabilities within virtual machines to ensure that the advanced capabilities are available for the workloads that require them. Accordingly, it would be desirable to be able to selectively expose advanced hardware capabilities to virtual machines so that the hardware is not overwhelmed.

### SUMMARY

An exemplary embodiment describes a computer system operable to selectively enable/disable a capability of a hardware device in a virtual machine. In this embodiment, the computer system includes, but is not limited to a logical processor; a hardware device; and a computer readable storage medium coupled to the logical processor and the hardware device. The computer readable storage medium in this exemplary embodiment can include instructions that upon execution cause the computer system to determine a set of hardware capabilities of the hardware device to expose in a virtual machine; instructions that upon execution cause the computer system to associate configuration information with a hardware device emulator for the hardware device, wherein the configuration information has a relationship to the determined set of hardware capabilities; instructions that upon execution cause the computer system to execute a guest operating system within the virtual machine; instructions that upon execution by the computer system cause the configuration information associated with the hardware device emulator to be detected; instructions that upon execution by the computer system cause a device driver from a group of device drivers to be selected, the selected device driver selected from the group based on a relationship between the configuration information and the device driver, wherein the selected device driver is configured to expose a set of driver interfaces to access the set of hardware capabilities; and instructions that upon execution by the computer system cause the guest operating system to load the device driver in the guest operating system. In addition to the foregoing, other techniques are described in the claims, the detailed description, and the figures.

In addition to a computer system, an exemplary embodiment provides an operational procedure for selectively enabling/disabling hardware capabilities in a virtual machine. The exemplary operational procedure includes, but is not limited to executing a hardware device emulator for a graphics processing unit, wherein the graphics processing unit includes a plurality of 3D capabilities; associating a first device identifier with the hardware device emulator; instantiating a virtual machine; loading, by a plug-and-play manager, a first device driver in accordance with a relationship between the first driver and the first device identifier, wherein the first device driver lacks interfaces for accessing 3D graphics capabilities; powering down the virtual machine; associating a second device identifier with the hardware device emulator; instantiating the virtual machine; and loading, by the plug-and-play manager, a second device driver in accordance with a relationship between the second device driver and the second device identifier, wherein the second device driver includes a 3D graphics interface for a capability of the 3D graphics processing unit. In addition to the foregoing, other techniques are described in the claims, the detailed description, and the figures.

In yet another example, a computer readable storage medium that include executable instructions operable to selectively enable/disable a hardware capability in a virtual machine is described. The exemplary computer readable storage medium can include instructions that when executed cause a computer system to select a device identifier from a group of device identifiers, the selected device identifier having a relationship to a set of 3D graphics capabilities of a graphics processing unit; instructions that when executed cause the computer system to execute a graphics processing unit emulator configured to expose the selected device identifier to a guest operating system of a virtual machine; instructions that when executed by a virtual processor of the virtual machine cause the guest operating system to select a device driver configured to expose a set of 3D graphics interfaces for accessing the set of 3D graphics capabilities based on a relationship between the device driver and the selected device identifier; and instructions that when executed by a virtual processor of the virtual machine cause the guest operating system to load the selected device driver in the virtual machine. In addition to the foregoing, other techniques are described in the claims, the detailed description, and the figures.

It can be appreciated by one of skill in the art that one or more various aspects of the disclosure may include but are not limited to circuitry and/or programming for effecting the herein-referenced aspects; the circuitry and/or programming can be virtually any combination of hardware, software, and/or firmware configured to effect the herein-referenced aspects depending upon the design choices of the system designer.

The foregoing is a summary and thus contains, by necessity, simplifications, generalizations and omissions of detail. Those skilled in the art will appreciate that the summary is illustrative only and is not intended to be in any way limiting.

### BRIEF DESCRIPTION OF THE DRAWINGS

FIG. 1 depicts an example computer system.

FIG. 2 depicts an operational environment describing an exemplary virtualization platform.

FIG. 3 depicts an operational environment describing an exemplary virtualization platform.

FIG. 4 depicts an operational environment for describing techniques for selectively enabling/disabling a hardware capability in a virtual machine.

FIG. 5 depicts an operational environment for describing techniques for selectively enabling/disabling a hardware capability in a virtual machine.

FIG. 6 depicts an operational environment for describing techniques for selectively enabling/disabling a hardware capability in a virtual machine.

FIG. 7 depicts an operational environment for describing techniques for selectively enabling/disabling a hardware capability in a virtual machine.

FIG. 8 depicts an operational environment for describing techniques for selectively enabling advanced capabilities of a 3D graphics processing unit in a virtual machine.

FIG. 9 depicts an operational procedure.

FIG. 10 depicts an operational procedure.

FIG. 11 depicts an operational procedure.

### DETAILED DESCRIPTION

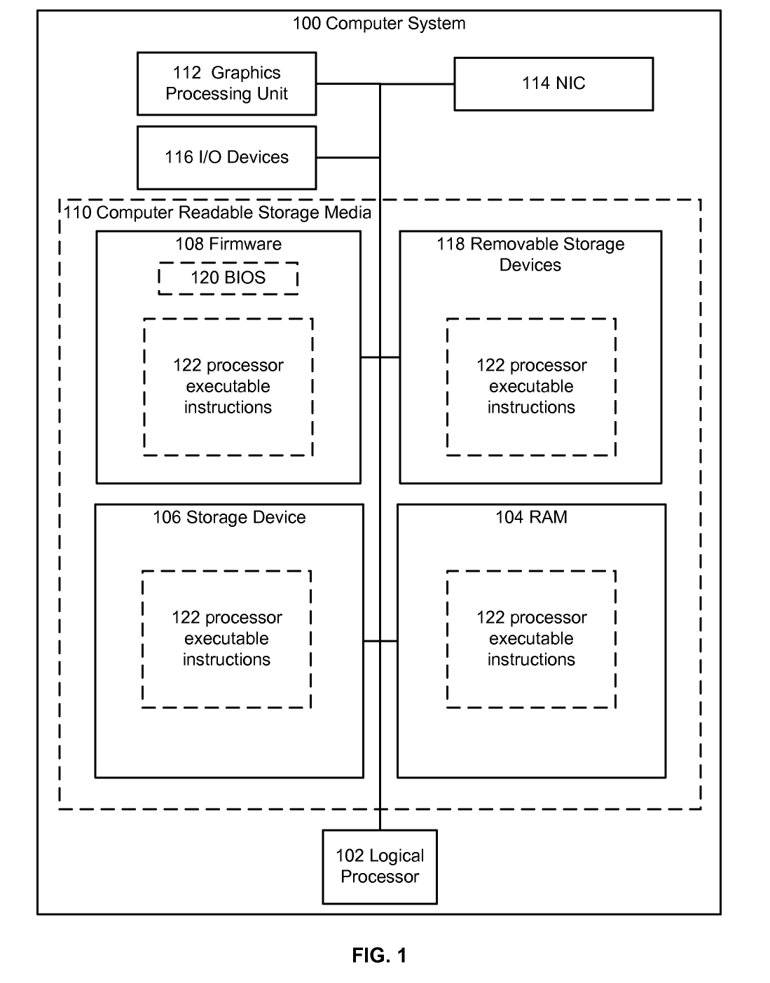

The disclosed subject matter may use one or more computer systems. FIG. 1 and the following discussion are intended to provide a brief general description of a suitable computing environment in which the disclosed subject matter may be implemented.

The term circuitry used throughout can include hardware components such as hardware interrupt controllers, hard drives, network adaptors, graphics processors, hardware based video/audio codecs, and the firmware used to operate such hardware. The term circuitry can also include microprocessors, application specific integrated circuits, and a logical processors, e.g., a core of a multi-core general processing unit, configured by firmware and/or software. Logical processor(s) can be configured by instructions loaded from memory, e.g., RAM, ROM, firmware, and/or mass storage, embodying logic operable to configure the logical processor to perform a function(s). In an example embodiment, where circuitry includes a combination of hardware and software, an implementer may write source code embodying logic that is subsequently compiled into machine readable code that can be executed by hardware. Since one skilled in the art can appreciate that the state of the art has evolved to a point where there is little difference between hardware implemented functions or software implemented functions, the selection of hardware versus software to effectuate herein described functions is merely a design choice. Put another way, since one of skill in the art can appreciate that a software process can be transformed into an equivalent hardware structure, and a hardware structure can itself be transformed into an equivalent software process, the selection of a hardware implementation versus a software implementation is left to an implementer.

Referring now to FIG. 1, an exemplary computing system 100 is depicted. Computer system 100 can include logical processor 102, e.g., an execution core. While one logical processor 102 is illustrated, in other embodiments computer system 100 may have multiple logical processors, e.g., multiple execution cores per processor substrate and/or multiple processor substrates that could each have multiple execution cores. As shown by the FIG., various computer readable storage media 110 can be interconnected by one or more system busses which couples various system components to the logical processor 102. The system buses may be any of several types of bus structures including a memory bus or memory controller, a peripheral bus, and a local bus using any of a variety of bus architectures. In example embodiments the computer readable storage media 110 can include for example, random access memory (RAM) 104, storage device 106, e.g., electromechanical hard drive, solid state hard drive, etc., firmware 108, e.g., FLASH RAM or ROM, and removable storage devices 118 such as, for example, CD-ROMs, floppy disks, DVDs, FLASH drives, external storage devices, etc. It should be appreciated by those skilled in the art that other types of computer readable storage media can be used such as magnetic cassettes, flash memory cards, and/or digital video disks.

The computer readable storage media 110 can provide non volatile and volatile storage of processor executable instructions 122, data structures, program modules and other data for the computer 100 such as executable instructions. A basic input/output system (BIOS) 120, containing the basic routines that help to transfer information between elements within the computer system 100, such as during start up, can be stored in firmware 108. A number of programs may be stored on firmware 108, storage device 106, RAM 104, and/or removable storage devices 118, and executed by logical processor 102 including an operating system and/or application programs.

Commands and information may be received by computer 100 through input devices 116 which can include, but are not limited to, a keyboard and pointing device. Other input devices may include a microphone, joystick, game pad, scanner or the like. These and other input devices are often connected to logical processor 102 through a serial port interface that is coupled to the system bus, but may be connected by other interfaces, such as a parallel port, game port, or universal serial bus (USB). A display or other type of display device can also be connected to the system bus via an interface, such as a video adapter which can be part of, or connected to, a graphics processor unit 112. In addition to the display, computers typically include other peripheral output devices, such as speakers and printers (not shown). The exemplary system of FIG. 1 can also include a host adapter, Small Computer System Interface (SCSI) bus, and an external storage device connected to the SCSI bus.

Computer system 100 may operate in a networked environment using logical connections to one or more remote computers, such as a remote computer. The remote computer may be another computer, a server, a router, a network PC, a peer device or other common network node, and typically can include many or all of the elements described above relative to computer system 100.

When used in a LAN or WAN networking environment, computer system 100 can be connected to the LAN or WAN through network interface card 114. The NIC 114, which may be internal or external, can be connected to the system bus. In a networked environment, program modules depicted relative to the computer system 100, or portions thereof, may be stored in the remote memory storage device. It will be appreciated that the network connections described here are exemplary and other means of establishing a communications link between the computers may be used. Moreover, while it is envisioned that numerous embodiments of the present disclosure are particularly well-suited for computerized systems, nothing in this document is intended to limit the disclosure to such embodiments.

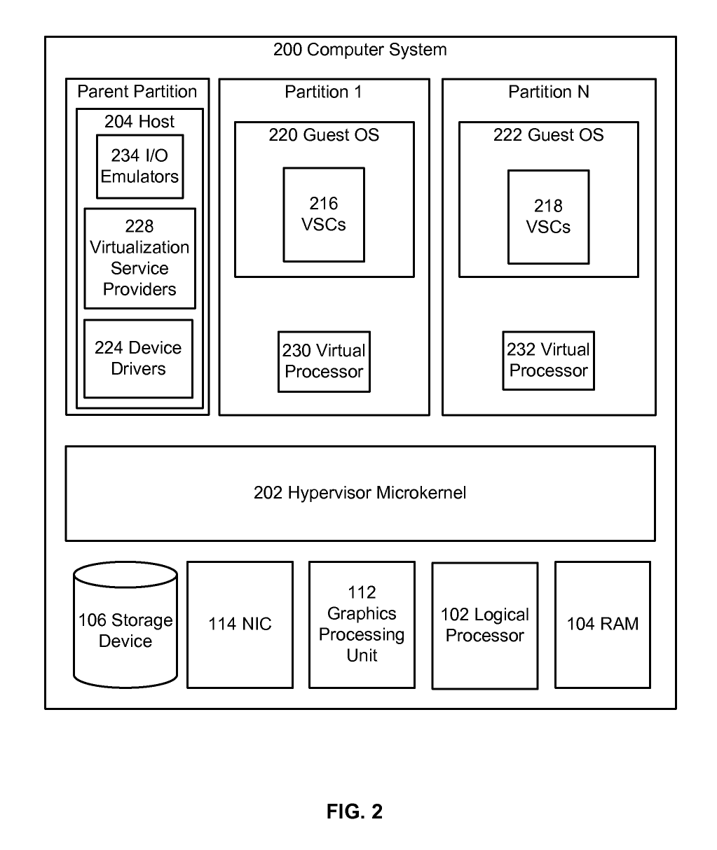

Turning to FIG. 2, illustrated is an exemplary virtualization platform that can be used to generate virtual machines. In this embodiment, hypervisor microkernel 202 can be configured to control and arbitrate access to the hardware of computer system 200. Hypervisor microkernel 202 can generate execution environments called partitions such as child partition 1 through child partition N (where N is an integer greater than 1). Here, a child partition is the basic unit of isolation supported by hypervisor microkernel 202. Hypervisor microkernel 202 can isolate processes in one partition from accessing another partition's resources. Each child partition can be mapped to a set of hardware resources, e.g., memory, devices, logical processor cycles, etc., that is under control of the hypervisor microkernel 202. In embodiments hypervisor microkernel 202 can be a stand-alone software product, a part of an operating system, embedded within firmware of the motherboard, specialized integrated circuits, or a combination thereof.

Hypervisor microkernel 202 can enforce partitioning by restricting a guest operating system's view of the memory in a physical computer system. When hypervisor microkernel 202 instantiates a virtual machine, it can allocate pages, e.g., fixed length blocks of memory with starting and ending addresses, of system physical memory (SPM) to the virtual machine as guest physical memory (GPM). Here, the guest's restricted view of system memory is controlled by hypervisor microkernel 202. The term guest physical memory is a shorthand way of describing a page of memory from the viewpoint of a virtual machine and the term system physical memory is shorthand way of describing a page of memory from the viewpoint of the physical system. Thus, a page of memory allocated to a virtual machine will have a guest physical address (the address used by the virtual machine) and a system physical address (the actual address of the page).

A guest operating system may virtualize guest physical memory. Virtual memory is a management technique that allows an operating system to over commit memory and to give an application sole access to a contiguous working memory. In a virtualized environment, a guest operating system can use one or more page tables to translate virtual addresses, known as virtual guest addresses into guest physical addresses. In this example, a memory address may have a guest virtual address, a guest physical address, and a system physical address.

In the depicted example, parent partition component, which can also be also thought of as similar to domain 0 of Xen's open source hypervisor can include a host 204. Host 204 can be an operating system (or a set of configuration utilities) and host 204 can be configured to provide resources to guest operating systems executing in the child partitions 1-N by using virtualization service providers 228 (VSPs). VPSs 228, which are typically referred to as back-end drivers in the open source community, can be used to multiplex the interfaces to the hardware resources by way of virtualization service clients (VSCs) (typically referred to as front-end drivers in the open source community or paravirtualized devices). As shown by the figures, virtualization service clients execute within the context of guest operating systems. However, these drivers are different than the rest of the drivers in the guest in that they may be supplied with a hypervisor, not with a guest. In an exemplary embodiment the path used to by virtualization service providers 228 to communicate with virtualization service clients 216 and 218 can be thought of as the virtualization path.

As shown by the figure, emulators 234, e.g., virtualized IDE devices, virtualized video adaptors, virtualized NICs, etc., can be configured to run within host 204 and are attached to resources available to guest operating systems 220 and 222. For example, when a guest OS touches a memory location mapped to where a register of a device would be or memory mapped device, microkernel hypervisor 202 can intercept the request and pass the values the guest attempted to write to an associated emulator. Here, the resources in this example can be thought of as where a virtual device is located. The use of emulators in this way can be considered the emulation path. The emulation path is inefficient compared to the virtualized path because it requires more CPU resources to emulate device than it does to pass messages between VSPs and VSCs. For example, the hundreds of actions on memory mapped to registers required in order to write a value to disk via the emulation path may be reduced to a single message passed from a VSC to a VSP in the virtualization path.

Each child partition can include one or more virtual processors (230 and 232) that guest operating systems (220 and 222) can manage and schedule threads to execute thereon. Generally, the virtual processors are executable instructions and associated state information that provide a representation of a physical processor with a specific architecture. For example, one virtual machine may have a virtual processor having characteristics of an Intel x86 processor, whereas another virtual processor may have the characteristics of a PowerPC processor. The virtual processors in this example can be mapped to logical processors of the computer system such that the instructions that effectuate the virtual processors will be backed by logical processors. Thus, in an embodiment including multiple logical processors, virtual processors can be simultaneously executed by logical processors while, for example, other logical processor execute hypervisor instructions. The combination of virtual processors and memory in a partition can be considered a virtual machine.

Guest operating systems (220 and 222) can be any operating system such as, for example, operating systems from Microsoft®, Apple®, the open source community, etc. The guest operating systems can include user/kernel modes of operation and can have kernels that can include schedulers, memory managers, etc. Generally speaking, kernel mode can include an execution mode in a logical processor that grants access to at least privileged processor instructions. Each guest operating system can have associated file systems that can have applications stored thereon such as terminal servers, e-commerce servers, email servers, etc., and the guest operating systems themselves. The guest operating systems can schedule threads to execute on the virtual processors and instances of such applications can be effectuated.

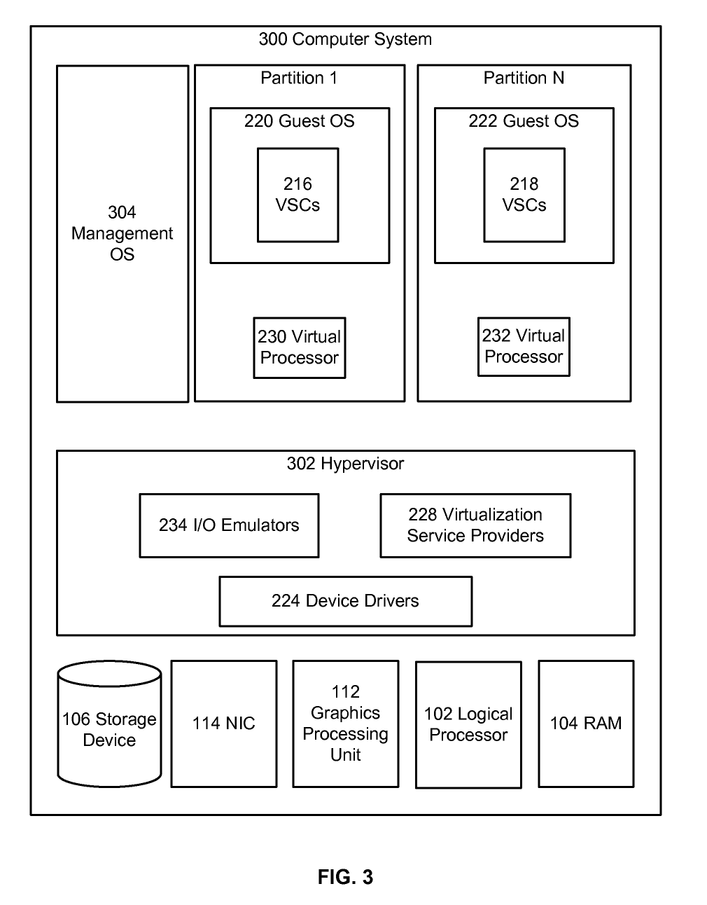

Referring now to FIG. 3, it illustrates an alternative virtualization platform to that described above in FIG. 2. FIG. 3 depicts similar components to those of FIG. 2; however, in this example embodiment hypervisor 302 can include a microkernel component and components similar to those in host 204 of FIG. 2 such as the virtualization service providers 228 and device drivers 224, while management operating system 304 may contain, for example, configuration utilities used to configure hypervisor 302. In this architecture, hypervisor 302 can perform the same or similar functions as hypervisor microkernel 202 of FIG. 2; however, in this architecture hypervisor 304 can be configured to provide resources to guest operating systems executing in the child partitions. Hypervisor 302 of FIG. 3 can be a stand alone software product, a part of an operating system, embedded within firmware of the motherboard or a portion of hypervisor 302 can be effectuated by specialized integrated circuits.

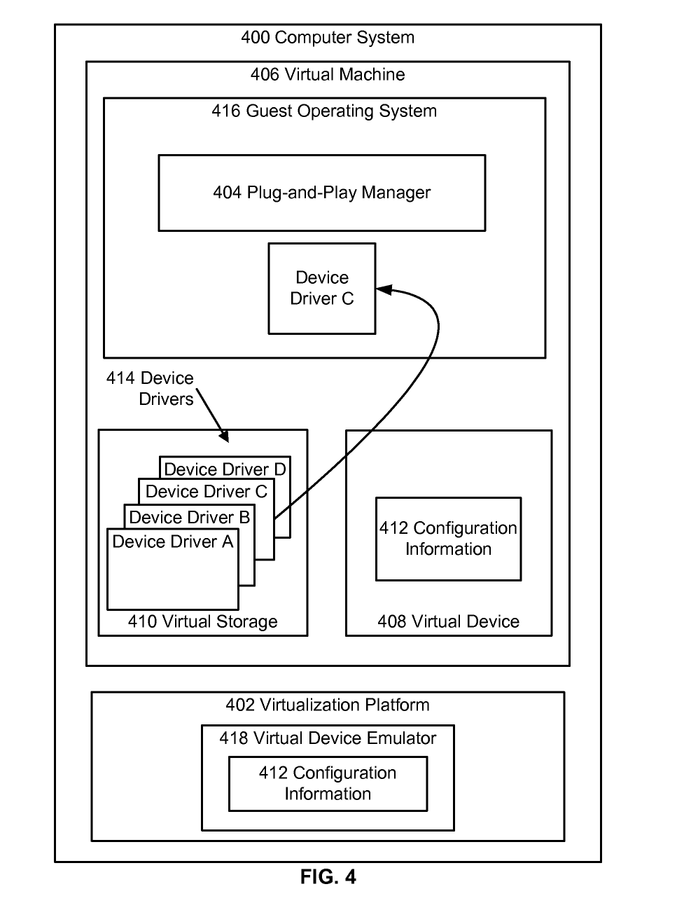

Turning to FIG. 4, it illustrates an exemplary system for describing aspects of the disclosure. Generally, FIG. 4 shows virtualization platform 402 configured to effectuate and manage virtual machine 406, which can run guest operating system 416. Virtualization platform 402 is a logical abstraction of virtualization infrastructure components such as those described above in FIG. 2 and FIG. 3. The elements described as part of virtualization platform 402 can be implemented in one or more elements depicted in FIG. 2 or FIG. 3. For example, in the instance that virtual device emulator 418 is implemented in an architecture similar to FIG. 2, it could be configured to execute in host 204 or hypervisor microkernel 202. In the instance that virtual device emulator 418 is implemented in an architecture similar to FIG. 3, it could be configured to execute in hypervisor 302. While the following disclosure will call out example configurations, the disclosure is not limited.

Here, virtualization platform 402 can leverage the native functionality of plug-and-play manager 404 and how operating systems (and applications) access hardware in order to selectively enable/disable virtual devices having different capabilities. Generally, the purpose of a device driver is to simplify the programming of higher level software by acting as a translator between a hardware device and the applications or operating systems that use it. Since the device driver is the interface to the hardware device, the only capabilities of a hardware device that can be accessed are those whose interfaces are exposed by the device driver. That is, if an interface to a hardware capability is not exposed to the OS (or an application) the OS can not access the capability. In an exemplary embodiment, virtualization platform 402 can leverage this configuration to cause plug-and-play manager 404 to select a specific device driver (device driver C in the illustrated example) in order to enable a specific set of hardware capabilities in virtual machine 406.

Virtualization platform 402 can cause a device driver (such as device driver C) to load from a group 414 stored in virtual storage, e.g., a virtual hard drive, by exposing select configuration information 412 to plug-and-play manager 404. For example, plug-and-play manager 404 is a software module that is typically executed by an operating system during its boot process. In a non-virtualized environment, a plug-and-play manager operates by identifying devices connected to a physical computer's address bus and uses configuration information burned into the devices to load device drivers. In the illustrated embodiment, virtualization platform 402 can be configured to change the configuration information used in order to cause plug-and-play manager 404 to load specific device drivers having specific hardware interfaces. In the illustrated example, virtualization platform 402 caused plug-and-play manager 404 to load device driver C in order to expose a specific set of capabilities in virtual machine 406 by exposing configuration information 412. In a specific example, exemplary devices can include peripheral component interconnect (PCI) compliant devices coupled to a PCI bus. In a PCI embodiment, plug-and-play manager 404 operates by reading vendor IDs and/or device IDs hardwired into registers mapped to a specific set of addresses that a logical processor can access. After plug-and-play manager 404 obtains the vendor IDs and/or device IDs from the registers, it can use the information to load an appropriate device driver for a hardware device.

Continuing with the general overview of FIG. 4, virtual device 408 is shown having configuration information 412. In this example, virtual device 408 can be thought of as the interface used to access virtual device emulator 418. Here, a group of intercepts can be set on resource allocated to virtual device 408 and if a software module attempts to touch the resources, an intercept can occur and the access can be sent to the emulator. In an exemplary embodiment, when a process touches a resource mapped to the location where configuration information 412 would be burned into a physical device, virtual device emulator 418 can execute and send configuration information 412 to the process.

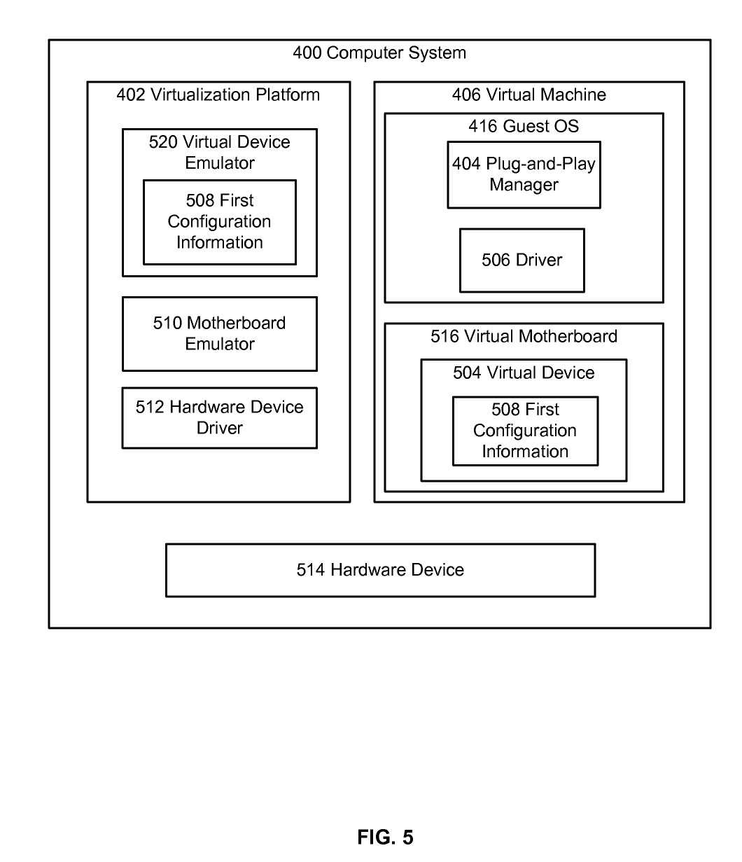

FIG. 5 illustrates an exemplary architecture for an embodiment where capabilities of a hardware device have been exposed and are accessed via an emulator. This configuration is useful for exposing the basic capabilities of a hardware device. However, the disclosure is not limited to using the configuration illustrated in FIG. 5 to only expose the basic capabilities of a hardware device; rather, advanced capabilities of hardware devices could be exposed in this configuration provided there is an emulator running in virtualization platform 402 operable to emulate such advanced capabilities.

Referring now to the elements of FIG. 5, it shows computer system 400 running virtualization platform 402 and virtual machine 406. Virtualization platform 402 is shown executing virtual device emulator 520, e.g., a process that emulates the functionality of a hardware device, motherboard emulator 510, and hardware device driver 512 used to control hardware device 514, e.g., a graphics processing unit, a network interface card, a hard drive, etc. In one exemplary configuration, virtual device emulator 520, motherboard emulator 510, and hardware device driver 512 could all run in a process of host operating system 204 similar to the environment described in FIG. 2. Similar to that shown in FIG. 4, configuration information 508 is used to cause plug-and-play manager 404 to load driver 506. Guest operating system 416 can then access the capabilities emulated by virtual device emulator 520 that are exposed by driver 506.

In a specific example, driver 506 may be a VGA driver. Thus, in this specific example, when driver 506 is loaded guest OS 416 cannot be capable of issuing advanced 3D commands to hardware device 514 since no interfaces to 3D capabilities are exposed. Or put another way, since guest operating system 416 is coded to access the hardware device via driver 506, OS 416 is dependent on the interfaces driver 506 exposes to hardware device 514. If the driver only exposes interfaces to access basic capabilities, then guest operating system 416 is limited to those capabilities regardless of what capabilities device emulator 520 or hardware device 514 actually has.

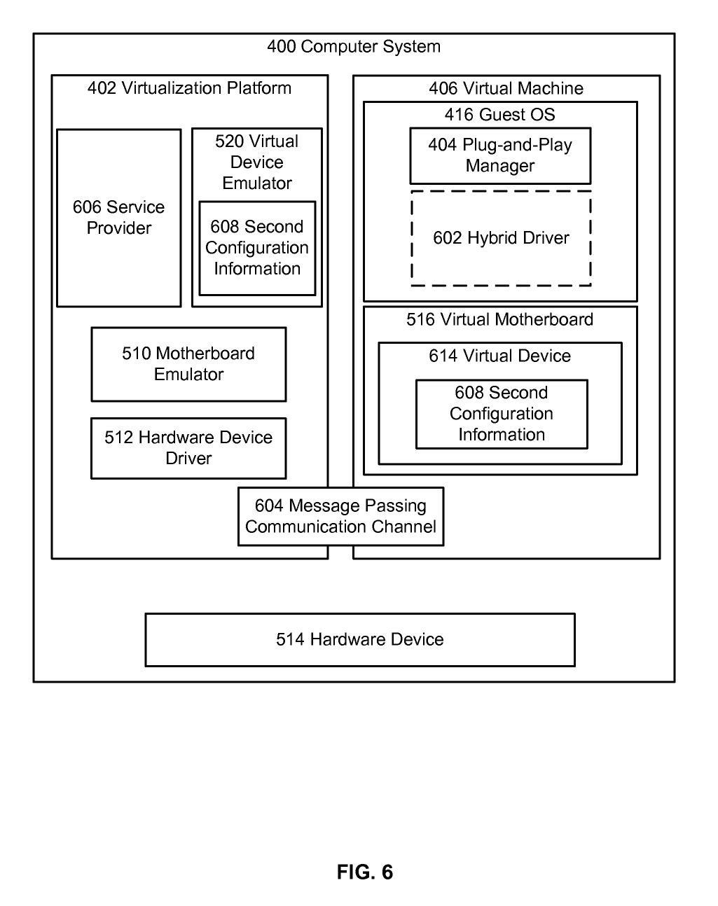

Turning to FIG. 6, it illustrates an instance where capabilities of a hardware device have been exposed and are accessed by hybrid driver 602. This exemplary configuration are useful for exposing advanced capabilities of a hardware device. However, the disclosure is not limited to using the configuration illustrated in FIG. 6 to expose advanced functionality. Instead, an emulator that emulates advanced capabilities of a hardware device could used.

Hybrid driver 602 can have features of a paravirtualized device and a non-virtualized device driver. Consequently, the hybrid driver 602 can exposes interfaces to a guest OS that can be mapped to either a virtualization path and an emulation path. When communicating over the virtualization path, hybrid driver 602 sends messages via message passing communication channel 604 to service provider 606 running in the virtualization platform 402. Service provider 606 processes the messages; translates guest commands into commands that can be handled by hardware device driver 512; and sends the commands to hardware device driver 512. In an embodiment, message passing communication channel 604 can include similar features to those described in U.S. patent application Ser. No. 11/128,647 entitled “Partition Bus,” the contents of which is herein incorporated by reference in its entirety.

The path used by hybrid driver 602 to communicate with virtualization platform 402 can be based the ability of an emulator to emulate certain capabilities and design choices made by an implementer. For example, in one configuration hybrid driver 602 can be configured to communicate via the emulation path, e.g., by setting virtual registers of virtual device 614, until an instance of message passing communication channel 604 is instantiated. In some exemplary configurations, an instance of message passing communication channel 604 is instantiated closer to the end of a boot process for guest OS 416 than hybrid driver 602. Here, hybrid driver 602 could be configured to communicate via the emulation path until an instance of message passing communication channel 604 is operational. At this point, hybrid driver 602 could be configured to operate in one of two modes: virtualized mode or hybrid mode. In another exemplary embodiment, an instance of message passing communication channel 604 can be instantiated before hybrid driver 602 is loaded. In this example, hybrid driver 602 could immediately start running in virtualized mode.

In an embodiment where hybrid driver 602 operates in hybrid mode, certain hardware capabilities can be emulated and others can be send to service provider 606. In virtualized mode, once an instance of message passing communication channel 604 is operational every hardware capability can be accessed via the virtualized path. In a specific example, an emulator could be coded to emulate 3 functions (A, B, and C), but hardware device 514, e.g., an IDE storage device, could have three capabilities (A, B, C, and D). In this exemplary embodiment, an implementer could configure hybrid driver 602 to use the emulation path when invoking capabilities A, B, or C and the virtualization path when invoking capability D. Here, when invoking capability D, hybrid driver 602 can use a high-level communication protocol to send commands to service provider 606 instead of configuring registers. For example, hybrid driver 602 could send data packets to service provider 606. Service provider 606 in this example could be configured to invoke capability D in hardware device driver 512. In another configuration, an implementer could configure hybrid driver to use the virtualized path for invoking capabilities A and D, or in another embodiment A, B, C, and D, can be accessed via the virtualization path after an instance of message passing communication channel 604 is operational.

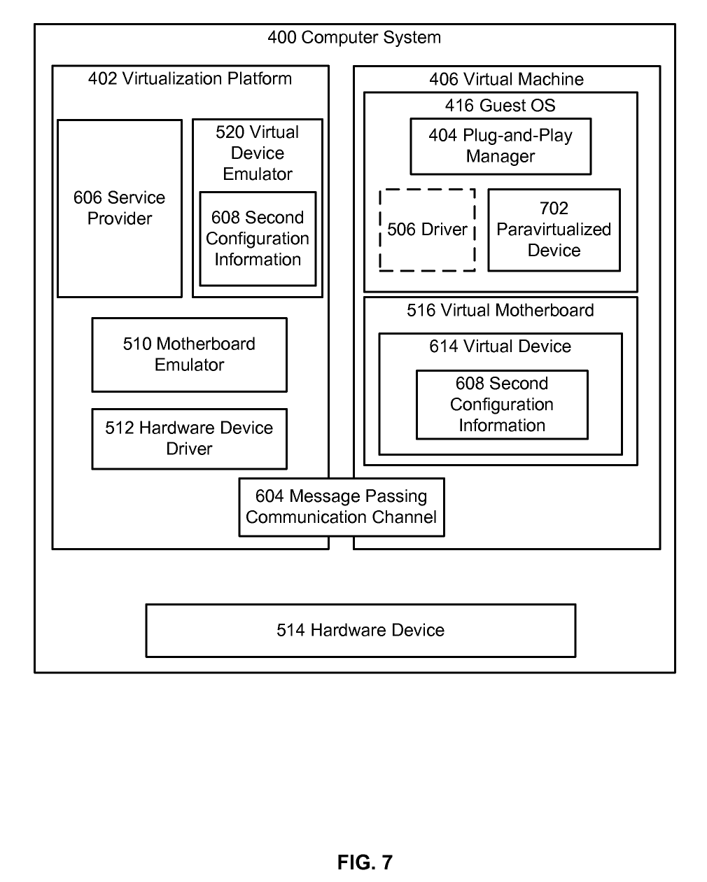

Turning to FIG. 7, it shows an alternative configuration where a paravirtualized device 702 is used to communicate with service provider 606. The figure also illustrates driver 506, which is shown in dashed lines to indicate that in an exemplary embodiment it turns off after paravirtualized device 702 loads. In an exemplary configuration, device driver 506 and paravirtualized device 702 can load when second configuration information 608 is detected. Device driver 506 can communicate with virtualization platform 402 until an instance of message passing communication channel 604 and paravirtualized device 702 are effectuated. At this point, in one exemplary embodiment device driver 508 can be shut down and paravirtualized device 702 can access hardware device 514 via service provider 606. In another configuration, device driver 508 can be used to access virtual device emulator 520 and paravirtualized device 702 can be configured to access hardware device 514 via service provider 606.

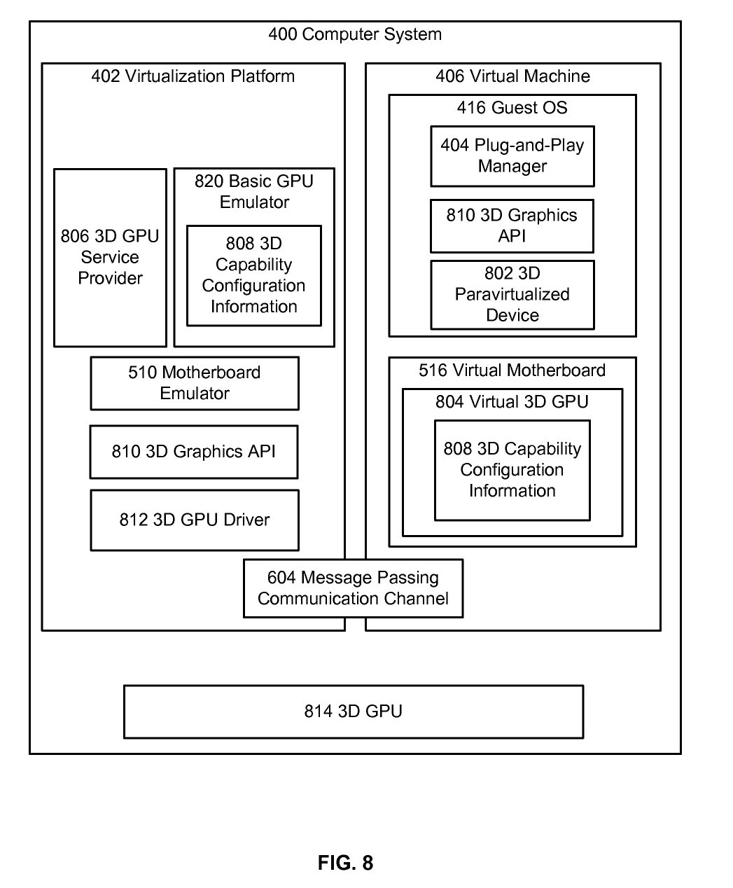

Turning now FIG. 8, it illustrates a specific embodiment where computer system 400 includes a 3D capable graphics processing unit 814. In this exemplary embodiment, 3D capability configuration information 808 can be used to expose 3D capabilities to guest OS 416. In an example, the capabilities could include all of the capabilities of a particular graphics processing unit, however in another example, the exposed capabilities could include the most common 3D capabilities offered by a current generation of graphics processing units. In a specific embodiment, the 3D capabilities exposed can include, but are not limited to, DirectX® support, cross-process sharing of graphics surfaces, i.e., memory that contains information about the texture meshes used to render 3D and 2D scenes, hardware acceleration, z-buffering, anti-aliasing, alpha blending, mipmapping, and/or atmospheric effects.

Continuing with the description of FIG. 8, in this exemplary embodiment 3D-paravirtualized device 802 can be loaded and used to communicate with 3D-GPU service provider 806. Similar to the embodiments described with respect to FIG. 7, after 3D-paravirtualized device 802 begins running a non-virtualized aware device driver could be stopped. However, the disclosure is not limited to the illustrated embodiment and a hybrid 3D-GPU driver, a vendor designed hybrid 3D-GPU driver, a vendor designed paravirtualized device, or a vendor designed non-virtualized aware driver could be used to access advanced 3D capabilities of 3D capable graphics processing unit 814.

FIG. 8 also illustrates an 3D graphics application program interface 810 (API), which can be an API such as Direct3D® from Microsoft® or OpenGL®. Briefly, 3D graphics API 810 provides an abstraction layer between a graphics application, e.g., any 3D capable application such as a videogame, and 3D-paravirtualized device 802. On one end, 3D graphics API 810 provides a low-level interface to graphics processing unit interfaces exposed by 3D-paravirtualized device 802 and on the other, it provides a library of 3D graphics commands that can be called by applications or operating systems. API 810 can map the library of 3D graphics commands to the interfaces exposed by the loaded device driver thereby freeing game developers from having to understand the particularities of every graphics driver.

3D-paravirtualized device 802 can send 3D commands associated with API 810 via the virtualization path to virtualization platform 402 in exemplary embodiments. For example, 3D-paravirtualized device 802 can send graphics commands via an instance of message passing communication channel 604 to 3D-GPU service provider 806. In operation, API 810 can generate primitives, e.g., the fundamental geometric shapes used in computer graphics as building blocks for other shapes represented as vertices and constants and store the vertices in a plurality of vertex buffers, e.g., pages of memory. When API 810 issues a render command, hybrid 3D-GPU driver 802 can translate the command into one or more GPU tokens and send the GPU tokens to 3D-GPU service provider 806 along with a description of the location of the vertex buffers. Virtualization platform 402 can translate the tokens into API calls and issue the API calls to another instance of API 810, which can issue 3D commands to 3D-GPU driver 812. Of course, in another exemplary embodiment the primitives could also be send via an instance of message passing communication channel 604. However, in this example the message passing communication channel 604 would have to have enough memory in order to efficiently transfer the primitives from VM 406 to virtualization platform 402.

In an alternative embodiment, a 3D driver, which could be a hybrid driver or a non-virtualized aware driver, can be developed by a third-party, e.g., a graphics processing unit vendor such as ATI®. In this exemplary embodiment, this third-party driver could be loaded instead of 3D-paravirtualized device 802. In the instance that it is a hybrid driver, the third-party driver can send GPU tokens via message passing communication channel 604 to 3D-GPU service provider 806. However, in this example there is a chance that the commands issued by the third-party hybrid driver are formatted according to a proprietary protocol and 3D-GPU service provider 806 may not understand the message format. Since 3D-GPU service provider 806 may not be able to translate the commands, in this embodiment the 3D-GPU 814 would have to be able to process commands issued by 3D-paravirtualized device 802. In this case, 3D-GPU service provider 806 can directly route the messages to 3D-GPU driver 812. In a PCI compliant embodiment, the Vendor ID register could be used to cause the third-party driver to be loaded by plug-and-playmodule 404.

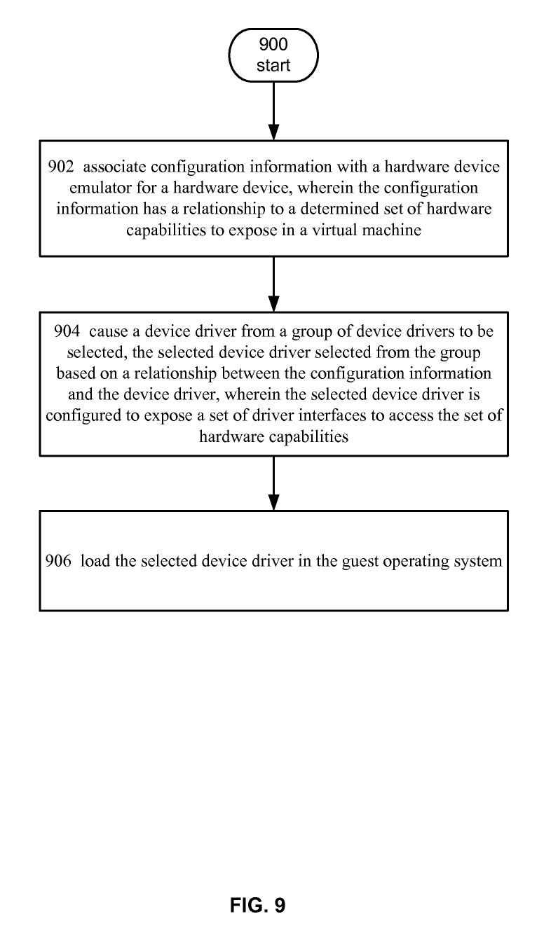

Turning to FIG. 9, it shows an operational procedure that can be performed by a computer system such as computer system 400. The operational procedure starts with operation 900, and continues with operation 902 which illustrates associating configuration information with a hardware device emulator for a hardware device, wherein the configuration information has a relationship to a determined set of hardware capabilities to expose in a virtual machine. In an exemplary embodiment, and turning to FIG. 4, virtualization platform 402, e.g., circuitry configured to effectuate host 204, can select configuration information 412 for a virtual device 408 and associate the information with virtual device emulator 418. For example, configuration information 412 can be stored in a specific location in RAM that virtual device emulator 418 accesses in the instance that a process in guest OS 416 attempts to access a resource allocated to virtual device 408, e.g., a location of a register that stores configuration information. In a specific example, configuration information 412 could include a device identifier and/or vendor identifier, which are typically stored in a Device ID register and a Vendor ID register of a PCI compliant device.

In an exemplary embodiment, configuration information 412 could be selected by virtualization platform 402 and associated with virtual device emulator 418 after virtualization platform 402 determines what hardware device capabilities to expose in virtual machine 406. In an exemplary embodiment, virtualization platform 402 can select configuration 412 based on information obtained from a configuration file. For example, virtualization platform 402, e.g., a process running in host 204, can read the configuration file and determine what to include in the virtual machine such as, for example, the amount of RAM, a number of virtual processors to expose, a size for a storage device, etc. In at least one embodiment, the configuration file can also include configuration information 412 for virtual device 408. In this example, virtualization platform 402 can select configuration information 412 from the file. In another example embodiment, the configuration file could instead have a list of hardware capabilities to enable for virtual device 408. Here, virtualization platform 402 can use the list to identify a driver that supports the enumerated capabilities and select configuration information 412 associated with the driver.

In an exemplary embodiment, configuration information can be set by an administrator. For example, virtualization platform 402 can expose a user interface that allows an administrator or the like to configure virtual machine 406. The administrator can select the desired characteristics for virtual machine 406 such as the capabilities to expose for each hardware device and instantiate VM 406. In a specific example, a user interface could allow a user to select a hardware device and then select individual hardware capabilities for the hardware device or different sets of capabilities. After the user is finished, he or she can save the configuration file and direct virtualization platform 402 to instantiate the virtual machine.

In the same, or another embodiment, the configuration file can be associated with a user account. In this example, virtualization platform 402 can be configured to instantiate a virtual machine in response to receiving a remote connection request from a remote user. Here, computer system 400 may be configured to host virtual machines for users that pay a monthly fee to be able to connect to a computer system via a public network such as the Internet. In this example, the display of virtual machine 406 could be send the user's remote computer system and user input can be sent to virtual machine 406 using a protocol such as the Remote Desktop Protocol® (RDP) developed by Microsoft®. The configuration file associated with the user account can be created based on what capabilities the user desires or has paid for. When the user attempts to connect to computer system 400, virtualization platform 402 can determine who the user is based on, for example, a username and password combination and/or a license and obtain configuration file.

Continuing with the description of FIG. 9, operation 904 illustrates that computer system 400 can include circuitry operable to cause a device driver from a group of device drivers to be selected, the selected device driver selected from the group based on a relationship between the configuration information and the device driver, wherein the selected device driver is configured to expose a set of driver interfaces to access the set of hardware capabilities. For example, and turning back to FIG. 4, after virtual machine 406 is instantiated with virtual device 408, plug-and-play manager 404 can be loaded and executed by a virtual processor. Plug-and-play manager 404 can attempt to read memory locations associated with virtual device 408, e.g., registers storing Vendor ID and/or Device ID values, and virtualization platform 402, e.g., microkernel hypervisor 202 of FIG. 2, can intercept the read access and transfer the read access to an emulator for the device. Virtual device emulator 418 can execute on a logical processor and determine that plug-and-play manager 404 attempted to access, for example, the Vendor ID and/or Device ID registers and direct virtualization platform 402 to respond with configuration information 412. Plug-and-play manager 404 can process configuration information 412 and select a driver based on a relationship between the driver and configuration information 412.

Continuing with the description of FIG. 9, operation 906 shows loading the device driver in the guest operating system. Referring back to FIG. 4, in this exemplary embodiment plug-and-play manager 404 can load the selected driver into guest operating system 416. Guest operating system 416 can then access the hardware capabilities exposed by the selected driver. Since guest operating system 416 accesses the hardware device via interfaces exposed by the selected driver, guest operating system 416 is limited to the hardware capabilities exposed by the loaded driver.

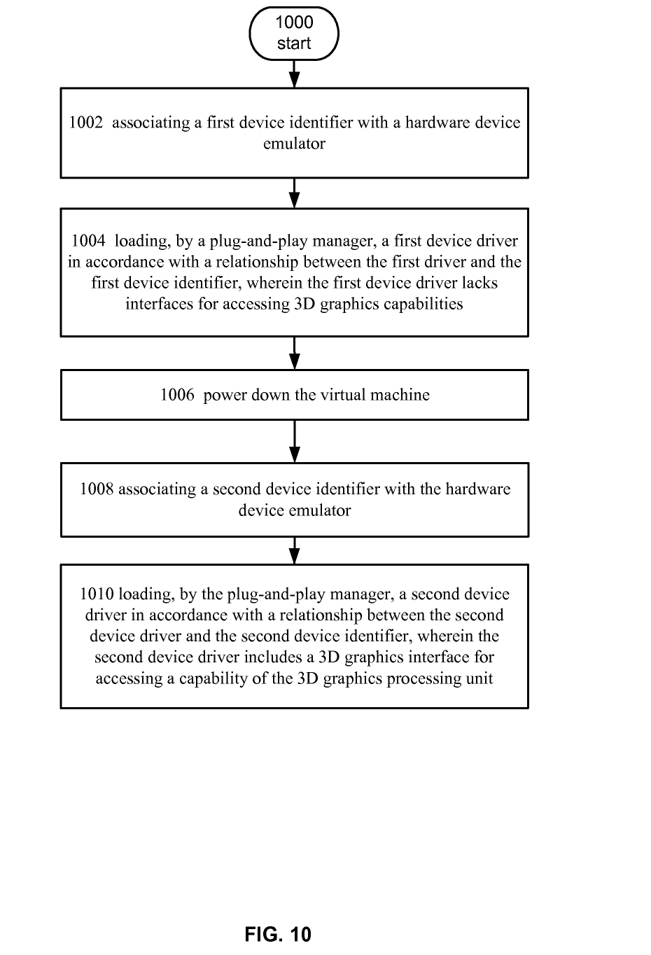

Turning now to FIG. 10, it illustrates an operational procedure for selectively enabling/disabling virtual devices in a virtual machine. As shown by the figure, operation 1000 begins the operational procedure and operation 1002 shows associating a first device identifier with a hardware device emulator. Turning to FIG. 5, in an exemplary embodiment computer system 400 can execute virtualization platform 402, which can receive a request to instantiate virtual machine 406, e.g., an administrator could select virtual machine 406 and select a button rendered on a screen to start virtual machine 406. Virtual machine 406 can be associated with a configuration file, which could include first configuration information (configuration information 508 in this example), e.g., a first device identifier that is associated with a virtual device that exposes a basic set of capabilities. For example, the device identifier could be for a VGA compliant device. In this example, virtualization platform 402 could access the configuration file and read the device identifier from the file. In another example, the configuration file could include a set of capabilities instead of a device identifier. Here, virtualization platform 402 can search a file of device identifiers for one that is associated with the set of capabilities and select it.

After the first device identifier is selected, it can be associated with virtual device emulator 520. For example, first device identifier can be stored in a memory location that is accessible by virtual device emulator 520. Virtual device emulator 520 can be configured to read the memory location and retrieve first device identifier in the instance that a process in virtual machine 406 attempts to read a register value. In a PCI embodiment, the register could be the Device ID register.

After virtualization platform 402 configures virtual device emulator 520, it can execute virtual machine 406. For example, virtualization platform 402 can allocate memory to virtual machine 406 and set intercepts on memory associated with IO devices such as the memory associated with where virtual device 504 would be coupled to a physical motherboard 516. In the event that guest operating system 416 or any other process attempts to read or write to the addresses, microkernel hypervisor 202 (or hypervisor 302) can intercept the access and pass the read or write to virtual device emulator 520. In a specific embodiment using an architecture similar to that depicted in FIG. 2, instantiating virtual machine 406 can be performed by hypervisor microkernel 202. In this specific example, hypervisor microkernel 202 can allocate RAM to virtual machine 406 and host 204 can execute a process that effectuates both virtual device emulator 520 and motherboard emulator 510. Inside of virtual machine 406, hypervisor intercepts can be set on ranges of memory that are allocated to virtual device 504 and virtual motherboard 516.

Continuing with the description of FIG. 10, operation 1004 shows loading, by a plug-and-play manager, a first device driver in accordance with a relationship between the first driver and the first device identifier, wherein the first device driver lacks interfaces for accessing 3D graphics capabilities. Continuing with the example above, after virtual machine 406 is setup, guest OS 416 can be executed by a virtual processor and plug-and-play manager 404 can be loaded. Plug-and-play manager 404 can run and attempt to read a register associated with virtual device 504. In response, virtualization platform 402 can intercept the read and pass it to virtual device emulator 520. Virtual device emulator 520 can be configured to emulate how a physical device would respond to a read operation; thus, virtual device emulator 520 can retrieve the first device identifier and send it to plug-and-play manager 404. Plug-and-play manager 404 can receive the device identifier and search a repository, e.g., a virtual hard drive, for a device driver that is associated with the device identifier and load the driver (in this example driver 506 could be the basic device driver). Guest OS 416 can load and start executing. In this example, the functionality of guest OS 416 is limited to the basic capabilities supported by the loaded driver.

Continuing with the description of FIG. 10, operation 1006 shows powering down the virtual machine. Here, virtual machine 406 can run and at some point guest operating system 416 can be shutdown, e.g., by a user. For example, guest operating system 416 can enter a shutdown routine where the virtual machine is powered down in a controlled way.

Sometime later, virtualization platform 402 can receive another request to instantiate virtual machine 406, except that in this instance virtual machine 406 is to have access to advanced hardware device capabilities. Here, as shown by operation 1008, a second device identifier can be associated with the hardware device emulator. In this example, the second device identifier can be associated with a set of advanced capabilities of the hardware device to expose to a guest operating system. Virtualization platform 402 can access configuration file that can include, for example, an association to a second device identifier or the second device identifier. For example, an administrator may have changed the configuration file when virtual machine 406 was off or a user may have paid to enable advanced features. Virtualization platform 402 can load a second device identifier into a memory location that is accessible to virtual device emulator 520 and instantiate virtual machine 406. In this example, when plug-and-play manager 404 executes a different virtual device will appear to plug-and-play manager 404. In a specific example, and turning to FIG. 6 or FIG. 7, the second device identifier can be associated with virtual device 614.

Turning to operation 1010, it shows loading, by the plug-and-play manager, a second device driver in accordance with a relationship between the second device driver and the second device identifier, wherein the second device driver includes a 3D graphics interface for accessing a capability of the 3D graphics processing unit. Turning back to FIG. 6 or FIG. 7, when plug-and-play manager 404 executes it can obtain the second device identifier, e.g., virtual device emulator 520 can respond with second device identifier. In this example, plug-and-play manager 404 can search a repository, e.g., a virtual hard drive and find a second device driver that is capable of exposing advanced capabilities of hardware device 514 to guest OS 416, e.g., paravirtualized device 702 or hybrid driver 602, and load it.

In the instance that a non-virtualized driver capable of exposing advanced capabilities of hardware device 514 is loaded in guest OS 416, advanced capability service provider 606 may not be used. In this example, the non-virtualized driver, which could be a standard driver provided by a vendor such as Nvidia® or ATI®, could operate normally virtual device emulator 520 that can emulate the functionality of such a graphics processing unit could be executed in virtualization platform 402.

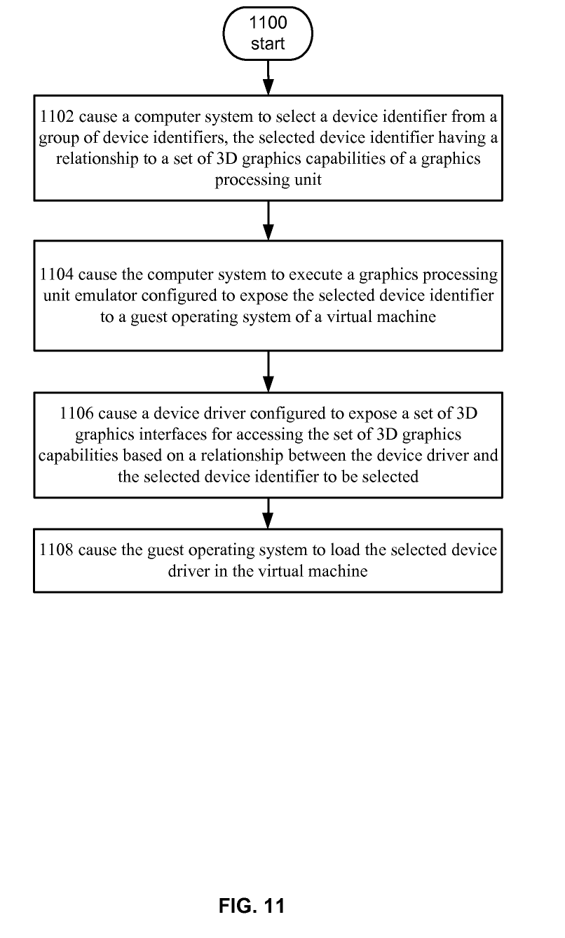

Turning now to FIG. 11, it illustrates an exemplary operational procedure for selectively enabling/disabling a virtual 3D-graphics processing unit. Operation 1100 begins the operational procedure and operation 1102 shows causing a computer system to select a device identifier from a group of device identifiers, the selected device identifier having a relationship to a set of 3D graphics capabilities of a graphics processing unit. For example, and turning to FIG. 8, virtualization platform 402 can execute on a logical processor and select 3D capability configuration information 808, which could include a device identifier in a specific embodiment. In this exemplary embodiment, a determination could have been made to expose the 3D capabilities of 3D-GPU 814 to virtual machine 406. For example, an administrator could determine to enable 3D capabilities for virtual machine 406. In another example embodiment, virtualization platform 402 could determine to enable 3D capabilities of 3D-GPU 814 for virtual machine 406 in response to information in a configuration file. In this example, virtualization platform 402 can execute and read the information contained therein. Virtualization platform 402 can then select a device identifier.

Continuing with the description of FIG. 11, operation 1004 shows causing the computer system to execute a graphics processing unit emulator configured to expose the selected device identifier to a guest operating system of a virtual machine. In this exemplary embodiment, virtualization platform 402 can load a process indicative of basic GPU emulator 820. In this example, the device identifier for a 3D capable device driver can be loaded into basic GPU emulator 820, e.g., the device identifier can be stored in a memory location accessible to the process indicative of basic GPU emulator.

Operation 1106 shows causing a device driver configured to expose a set of 3D graphics interfaces for accessing the set of 3D graphics capabilities based on a relationship between the device driver and the selected device identifier to be selected. For example, and turning back to FIG. 8, in an exemplary embodiment plug-and-play manager 404 can be executed by a virtual processor in virtual machine 406. In this example, plug-and-play manager 404 can attempt to read memory locations associated with virtual 3D GPU 804, e.g., registers storing Vendor ID and/or Device ID values, and virtualization platform 402, e.g., hypervisor 302 of FIG. 3, can intercept the read access and transfer the read access to 2D GPU emulator 820. 2D GPU emulator 820, which may only be capable of emulating basic capabilities common to almost all graphics processing units, can determine that plug-and-play manager 404 attempted to access, for example, the Vendor ID and/or Device ID registers and direct virtualization platform 402 to respond to the read access with the selected device ID.

Turning back to operation 1108, it shows causing the guest operating system to load the selected device driver in the virtual machine. In this example, plug-and-play manager 404 can detect the Device ID and load, for example, 3D-paravirtualized device 802, which can be configured to access advanced capabilities of 3D-graphics processing unit 814 via the virtualized path instead of the emulation path.

In an exemplary embodiment, 3D-paravirtualized device 802 can load after an instance of message passing communication channel 604 is opened between virtual machine 406 and virtualization platform 402, e.g., between VM 406 and host 204 of FIG. 2. For example, guest OS 416 can be configured to load an instance of message passing communication channel 604 at a specific point in time during the boot process and until it is loaded a non-virtualized basic device driver could run. When accessing 3D capabilities offered by 3D-GPU 814, 3D-paravirtualized device 802 can operate similar to how it was described above with respect to FIG. 7.

The foregoing detailed description has set forth various embodiments of the systems and/or processes via examples and/or operational diagrams. Insofar as such block diagrams, and/or examples contain one or more functions and/or operations, it will be understood by those within the art that each function and/or operation within such block diagrams, or examples can be implemented, individually and/or collectively, by a wide range of hardware, software, firmware, or virtually any combination thereof.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein.

What is claimed is:

1. A computer system operable to selectively enable/disable a capability of a hardware device in a virtual machine, comprising:
a logical processor;
a hardware device; and
a computer readable-storage medium coupled to the logical processor and the hardware device, the computer-readable storage medium, comprising:
instructions that upon execution cause the computer system to determine a set of hardware capabilities of the hardware device to expose in a virtual machine;
instructions that upon execution cause the computer system to associate configuration information with a hardware device emulator for the hardware device, wherein the configuration information has a relationship to the determined set of hardware capabilities;
instructions that upon execution cause the computer system to execute a guest operating system within the virtual machine;
instructions that upon execution by the computer system cause the configuration information associated with the hardware device emulator to be detected by the guest operating system;
instructions that upon execution by the computer system cause a device driver from a group of device drivers to be selected, the selected device driver selected from the group based on a relationship between the configuration information and the device driver, wherein the selected device driver is configured to expose a set of driver interfaces to access the set of hardware capabilities; and
instructions that upon execution by the computer system cause the guest operating system to load the device driver in the guest operating system.

2. The computer system of claim 1, wherein the set of hardware capabilities includes a set of 3D graphics processing unit capabilities of a 3D graphics processing unit.

3. The computer system of claim 1, wherein the hardware device emulator is configured to emulate a peripheral component interconnect compliant hardware device, wherein the configuration information includes a device identifier and the hardware device emulator is configured to expose the device identifier to the virtual machine as being stored in a virtual register.

4. The computer system of claim 1, wherein the computer-readable storage medium further comprises:
instructions that upon execution by the computer system cause 3D graphics commands generated by a 3D application program interface executing within the guest operating system to be sent to a hypervisor via a message passing communication channel established between the hypervisor and the virtual machine.

5. The computer system of claim 1, wherein the computer-readable storage medium further comprises:
instructions that upon execution by the computer system cause 3D graphics commands generated by a 3D application program interface executing within the guest operating system to be sent to a host operating system via a message passing communication channel established between the hypervisor and the virtual machine.

6. The computer system of claim 1, wherein the computer-readable storage medium further comprises:
instructions that upon execution cause the computer system to process a request to instantiate the virtual machine, the request associated with a remote access connection request.

7. The computer system of claim 1, wherein the configuration information includes a vendor identifier and the selected device driver is associated with the vendor identifier.

8. A method for selectively enabling/disabling hardware capabilities in a virtual machine, comprising:
executing a hardware device emulator for a graphics processing unit, wherein the graphics processing unit includes a plurality of 3D capabilities;
associating a first device identifier with the hardware device emulator;
instantiating a virtual machine;
loading, by a plug-and-play manager, a first device driver in accordance with a relationship between the first driver and the first device identifier, wherein the first device driver lacks interfaces for accessing 3D graphics capabilities;
powering down the virtual machine;
associating a second device identifier with the hardware device emulator;
instantiating the virtual machine; and
loading, by the plug-and-play manager, a second device driver in accordance with a relationship between the second device driver and the second device identifier, wherein the second device driver includes a 3D graphics interface for accessing a capability of the 3D graphics processing unit.

9. The method of claim 8, wherein the hardware device emulator is configured to emulate a peripheral component interconnect compliant hardware device.

10. The method of claim 8, further comprising:
sending, by the second device driver, 3D graphics application program commands to a host operating system via a message passing communication channel.

11. The method of claim 8, further comprising:
sending, by the second device driver, 2D graphics application program commands to a host operating system via a message passing communication channel.

12. The method of claim 8, further comprising:
intercepting, by a hypervisor, read/write requests associated with 2D graphics capabilities issued by the second device driver and sending the read/write requests to the hardware device emulator.

13. A computer-readable storage medium including executable instructions operable to selectively enable/disable a hardware capability in a virtual machine, comprising:
instructions that when executed cause a computer system to select a device identifier from a group of device identifiers, the selected device identifier having a relationship to a set of 3D graphics capabilities of a graphics processing unit;
instructions that when executed cause the computer system to execute a graphics processing unit emulator configured to expose the selected device identifier to a guest operating system of a virtual machine;
instructions that when executed by a virtual processor of the virtual machine cause a device driver configured to expose a set of 3D graphics interfaces for accessing the set of 3D graphics capabilities based on a relationship between the device driver and the selected device identifier to be selected; and
instructions that when executed by a virtual processor of the virtual machine cause the guest operating system to load the selected device driver in the virtual machine.

14. The computer-readable storage medium of claim 13, wherein the graphics processing unit emulator is configured to emulate a peripheral component interconnect compliant graphics processing unit, wherein the configuration information includes a device identifier that is exposed in the virtual machine as being stored in a virtual register.

15. The computer-readable storage medium of claim 13, wherein the group of hardware device identifiers includes a hardware device identifier associated with a device driver lacking interfaces for exposing 3D graphics capabilities and a vendor specific device driver including interfaces for exposing 3D graphics capabilities of the 3D graphics processing unit.

16. The computer-readable storage medium of claim 13, further comprising:
instructions that upon execution cause the computer system to send the selected device identifier to a plug-and-play manager executing in the guest operating system in response to determining that the plug-and-play manager attempted to access memory mapped to a virtual graphics processing unit.

17. The computer-readable storage medium of claim 13, further comprising:
instructions that upon execution cause the computer system to process a request to instantiate the virtual machine, the request associated with a remote access connection request.

18. The computer-readable-storage medium of claim 13, wherein the set of 3D graphics capabilities of the graphics processing unit includes all of the 3D graphics capabilities of the graphics processing unit.

19. The computer-readable storage medium of claim 13, further comprising:
instructions that upon execution cause the computer system to send 3D graphics application program interface commands to a host operating system via a message passing communication bus.

20. The computer-readable storage medium of claim 13, further comprising:
instructions that upon execution cause the computer system to intercept a write operation to a memory location mapped to a virtual graphics processing unite and send the write operation to the graphics processing unit emulator.
